(19) United States
(12) Patent Application Publication
(10) Pub. No.: US 2022/0317747 A1
(43) Pub. Date: Oct. 6, 2022

(54) POWER SHIFTING BASED ON BOTTLENECK PREDICTION

(71) Applicants: ADVANCED MICRO DEVICES, INC., SANTA CLARA, CA (US); ATI TECHNOLOGIES ULC, MARKHAM (CA)

(72) Inventors: WONJE CHOI, AUSTIN, TX (US); MICHAEL J. AUSTIN, AUSTIN, TX (US); INDRANI PAUL, AUSTIN, TX (US); MEETA SRIVASTAV, AUSTIN, TX (US); ALEXANDER SABINO DUENAS, MARKHAM (CA)

(21) Appl. No.: 17/219,020

(22) Filed: Mar. 31, 2021

(51) Int. Cl. G06F 1/26

(52) U.S. Cl. CPC G06F 1/26

(57) ABSTRACT

Power shifting based on bottleneck prediction, including: determining a first plurality of performance metrics for an accelerated processing unit (APU) and a second plurality of performance metrics for a graphics processing unit (GPU); providing the first plurality of performance metrics and the second plurality of performance metrics as an input to a model configured to identify one or more bottlenecks in the APU or the GPU; determining, based on an output of the model, a power distribution between the APU and the GPU; and applying the power distribution.

### BACKGROUND

In some computing devices, an Accelerated Processing Unit (APU) and a Graphics Processing Unit (GPU) share a same power and thermal envelope. That is, both the APU and the GPU derive power from a same source, and thus power must be distributed to the APU and the GPU in some proportion. Depending on the particular applications and processes executed by the computing device, one or more of the APU and the GPU are susceptible to bottlenecks, thereby degrading performance. Though such bottlenecks can be alleviated by increasing the power supplied to the bottlenecked component, it is difficult to identify such bottlenecks in order to compensate accordingly.

### BRIEF DESCRIPTION OF THE DRAWINGS

FIG. 1 is a block diagram of an example apparatus for power shifting based on bottleneck prediction according to some embodiments.

FIG. 2 is a flowchart of an example method for power shifting based on bottleneck prediction according to some embodiments.

FIG. 3 is a flowchart of another example method for power shifting based on bottleneck prediction according to some embodiments.

FIG. 4 is a flowchart of another example method for power shifting based on bottleneck prediction according to some embodiments.

FIG. 5 is a flowchart of another example method for power shifting based on bottleneck prediction according to some embodiments.

FIG. 6 is a flowchart of another example method for power shifting based on bottleneck prediction according to some embodiments.

FIG. 7 is a flowchart of another example method for power shifting based on bottleneck prediction according to some embodiments.

### DETAILED DESCRIPTION

In some embodiments, a method of power shifting based on bottleneck prediction includes determining a first plurality of performance metrics for an accelerated processing unit (APU) and a second plurality of performance metrics for a graphics processing unit (GPU); providing the first plurality of performance metrics and the second plurality of performance metrics as an input to a model identifying one or more bottlenecks in the APU or the GPU; determining, based on an output of the model, a power distribution between the APU and the GPU; and applying the power distribution.

In some embodiments, the method further includes determining a priority bias between the APU and the GPU. In some embodiments, the method further includes determining, based on the priority bias between the APU and the GPU, the model from a plurality of models. In some embodiments, the method further includes modifying, based on the priority bias between the APU and the GPU, at least a portion of the input to the model. In some embodiments, the method further includes modifying, based on the priority bias between the APU and the GPU, the power distribution. In some embodiments, the method further includes: identifying an executed application; and wherein determining the power distribution includes determining the power distribution based on the executed application. In some embodiments, the output of the model includes a first power level and a first frequency for the APU and a second power level and a second frequency for the GPU. In some embodiments, the plurality of first performance metrics or the plurality of second performance metrics include one or more of: one or more instruction retirement metrics, one or more memory utilization metrics, one or more cache activity metrics, or one or more bus utilization metrics. In some embodiments, the first plurality of performance metrics are received from a first microcontroller of the APU and the second plurality of performance metrics are received from a second microcontroller of the GPU.

In some embodiments, an apparatus for power shifting based on bottleneck prediction includes: an APU; a GPU; and the apparatus performs steps including: determining a first plurality of performance metrics for the APU and a second plurality of performance metrics for the GPU; providing the first plurality of performance metrics and the second plurality of performance metrics as an input to a model configured to identify one or more bottlenecks in the APU or the GPU; determining, based on an output of the model, a power distribution between the APU and the GPU; and applying the power distribution.

In some embodiments, the steps further include determining a priority bias between the APU and the GPU. In some embodiments, the steps further include determining, based on the priority bias between the APU and the GPU, the model from a plurality of models. In some embodiments, the steps further include modifying, based on the priority bias between the APU and the GPU, at least a portion of the input to the model. In some embodiments, the steps further include modifying, based on the priority bias between the APU and the GPU, the power distribution. In some embodiments, the steps further include: identifying an executed application; and wherein determining the power distribution includes determining the power distribution based on the executed application. In some embodiments, the output of the model includes a first power level and a first frequency for the APU and a second power level and a second frequency for the GPU. In some embodiments, the plurality of first performance metrics or the plurality of second performance metrics include one or more of: one or more instruction retirement metrics, one or more memory utilization metrics, one or more cache activity metrics, or one or more bus utilization metrics. In some embodiments, the first plurality of performance metrics are received from a first microcontroller of the APU and the second plurality of performance metrics are received from a second microcontroller of the GPU.

In some embodiments, a computer program product disposed upon a non-transitory computer readable medium includes computer program instructions for power shifting based on bottleneck prediction, that, when executed, cause a computer system to perform steps including: determining a first plurality of performance metrics for an APU and a second plurality of performance metrics for a GPU; providing the first plurality of performance metrics and the second plurality of performance metrics as an input to a model identifying one or more bottlenecks in the APU or the GPU; determining, based on an output of the model, a power distribution between the APU and the GPU; and applying the power distribution.

In some embodiments, the steps further include determining a priority bias between the APU and the GPU.

In some computing devices, an Accelerated Processing Unit (APU) and a Graphics Processing Unit (GPU) share a same power envelope. That is, both the APU and the GPU derive power from a same source, and thus power must be distributed to the APU and the GPU in some proportion. Depending on the particular applications and processes executed by the computing device, one or more of the APU and the GPU are susceptible to bottlenecks, thereby degrading performance. Though such bottlenecks can be alleviated by increasing the power supplied to the bottlenecked component, it is difficult to identify such bottlenecks in order to compensate accordingly.

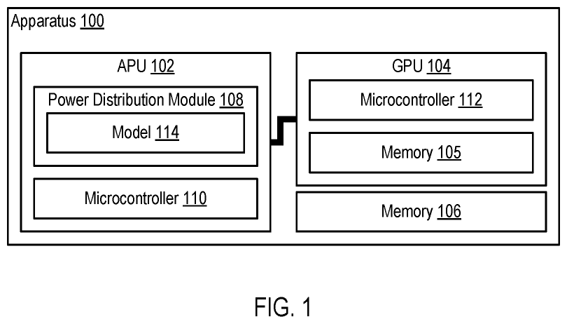

To address such shortcomings, FIG. 1 is a block diagram of a non-limiting example apparatus 100 for power shifting based on bottleneck prediction according to embodiments of the present disclosure. The example apparatus 100 can be implemented in a variety of computing devices, including mobile devices, personal computers, peripheral hardware components, gaming devices, set-top boxes, and the like. The apparatus 100 includes an Accelerated Processing Unit (APU) 102. The APU 102 is a microprocessor that includes a central processing unit (CPU) as well as integrated graphics processing computing blocks on a single die. The apparatus 100 also includes a graphics processing unit (GPU) 104. The GPU 104 is a peripheral or additional component of the apparatus 100 operatively coupled to the APU 102. For example, in some embodiments the GPU 104 is operatively coupled to the APU 102 by a peripheral component interface express (PCIe) bus. Accordingly, in such an embodiment, the GPU 104 is installed in a PCIe port on a motherboard or other printed circuit board (PCB) into which the APU 102 is installed. By virtue of the operable connection between the APU 102 and the GPU 104, the APU 102 is capable of issuing instructions, rendering jobs, and the like, to the GPU 104. The GPU 104 includes dedicated, on-device memory 105 for storing data used during various processes executed by the GPU 104. The apparatus 100 also includes memory 106 such as Random Access Memory (RAM). Accordingly, during operation of the apparatus 100, the memory 106 is used to store software, operating systems, services, applications, and the like for execution, as well as store values generated by the execution of instructions by the APU 102 and the GPU 104.

The APU 102 implements a power distribution module 108, a module for power shifting based on bottleneck prediction according to embodiments of the present disclosure. In some embodiments, the power distribution module 108 is implemented as firmware logic of the APU 102. The power distribution module 108 determines a power distribution for the APU 102 and the GPU 104. In some embodiments, the power distribution is expressed as a ratio of available power in the apparatus 100 as distributed between the APU 102 and the GPU 104. In some embodiments, the power distribution is expressed as a particular amount of power (e.g., voltage) to be applied to each of the APU 102 and the GPU 104. In some embodiments, the power distribution includes an operating frequency for the APU 102 and the GPU 104. As an example, in some embodiments, the power distribution includes a first power level (e.g., a first power output or a first portion of a ratio) and a first frequency for the APU 102 and a second power level (e.g., a second power output or a second portion of the ratio) and a second frequency for the GPU 104.

To determine the power distribution between the APU 102 and the GPU 104, the power distribution module 108 receives a first plurality of performance metrics from the APU 102 and a second plurality of performance metrics from the GPU 104. In some embodiments, the first plurality of performance metrics and the second plurality of performance metrics include counters describing a number of times a particular event has occurred in the APU 102 or GPU 104 (e.g., in total, within a particular time interval, and the like). As an example, the first plurality of performance metrics and the second plurality of performance metrics include instruction retirement metrics such as counters describing a number of instructions retired or committed (e.g., in total or with respect to a particular type of instruction). As another example, the first plurality of performance metrics and the second plurality of performance metrics include memory utilization metrics such as a number of memory accesses (e.g., accesses to memory 105 or memory 106) or a number of a particular type of memory access (e.g., read or write). As another example, the first plurality of performance metrics and the second plurality of performance metrics include cache activity metrics such as a number of cache hits or cache misses. As a further example, the first plurality of performance metrics and the second plurality of performance metrics include bus utilization metrics such as a degree of usage of a memory bus, a PCIe bus (e.g., the PCIe bus between the APU 102 and the GPU 104), and the like. In some embodiments, the first plurality of performance metrics and the second plurality of performance metrics include a degree of occupancy or utilization of the APU 102 and GPU 104. One skilled in the art will appreciate that other performance metrics are also usable in the approaches set forth herein.

In some embodiments, the first plurality of performance metrics are received by the power distribution module 108 from a first microcontroller 110 of the APU 102 and the second plurality of performance metrics are received from a second microcontroller 112 of the GPU 104. For example, the first microcontroller 110 calculates the first plurality of performance metrics relative to the APU 102 (e.g., instructions retired by the APU 102, memory accesses by the APU 102, bus utilization by the APU 102, and the like) and provides the first plurality of performance metrics to the power distribution module 108. The second microcontroller 112 calculates the second plurality of performance metrics relative to the GPU 104 (e.g., instructions retired by the GPU 104, memory accesses by the GPU 104, bus utilization by the GPU 104, and the like) and provides the second plurality of performance metrics to the power distribution module 108.

The first plurality of performance metrics and the second plurality of performance metrics are then provided, by the power distribution module 108, as inputs to a model 114 trained or defined to identify one or more bottlenecks in the APU 102 or the GPU 104. Performance bottlenecks prevent the scaling of performance of one application-specific integrated circuit (ASIC) via added power budget due to some internal or external limitation like lack of memory bandwidth, instruction or data co-dependency between functional blocks of the system, or outside influence from software (e.g., operating system or driver layers). As an example, in some embodiments, the model 114 includes a trained machine learning model 114 trained to identify one or more bottlenecks in the APU 102 or the GPU 104 based on the first plurality of performance metrics and the second plurality of performance metrics (e.g., a classifier model 114). As another example, in some embodiments, the model 114 includes an algorithmic or user-defined model 114 based on identifying bottlenecks in the APU 102 or the GPU 104. In some embodiments, the model 114 is stored in the firmware of the APU 102. In some embodiments, the model 114 is trained or generated prior to storage in the firmware of the APU 102 (e.g., trained or generated off-chip).

Various behaviors relating to the first plurality of performance metrics and the second plurality of performance metrics will indicate a bottleneck in the APU 102 or the GPU 104. For example, where the occupancy or usage of the APU 102 or GPU 104 is at or near a maximum, this indicates a bottleneck at the respective APU 102 or GPU 104. As another example, there usage or a component is lower, or a component is performing relatively few instruction retirement events, it indicates that the particular component is likely not the source of a bottleneck. As a further example, a component experiencing a large degree of cache misses is potentially the source of a bottleneck. One skilled in the art will appreciate that various behaviors associated with the first plurality of performance metrics and the second plurality of performance metrics, and that the particular relationships between performance metrics and bottlenecks will be expressed in the particular trainings or encodings of the model 114.

The power distribution module 108 then determines, based on an output of the model, a power distribution between the APU 102 and the GPU 104. In some embodiments, the model 114 outputs the power distribution directly. That is, in some embodiments, the output of the model 114 includes a first power level and a first frequency for the APU 102 and a second power level and a second frequency for the GPU 104. Accordingly, the power distribution determined by the power distribution module 108 is the output of the model 114 itself. In other embodiments, the output of the model 114 includes one or more confidence scores relative to a particular power distribution. Accordingly, in such an embodiment, the power distribution module 108 determines the power distribution based on the confidence scores output by the power distribution module 108. In further embodiments, the output of the model 114 includes an amount to modify the power and frequency of the APU 102 and GPU 104 (e.g., a particular amount to shift the power up or down for each of the APU 102 and GPU 104 and a particular amount to shift the frequency up or down for each of the APU 102 and GPU 104). The power distribution module 108 then determines the power distribution between the APU 102 and the GPU 104 by calculating updated respective power levels and frequencies for the APU 102 and the GPU 104.

After determining the power distribution, the power distribution module 108 then applies the power distribution. For example, the power distribution module 108 provides a command or signal to a voltage controller or other power regulating component of the apparatus to provide power to the APU 102 and the GPU 104 according to the determined power distribution. As another example, the power distribution module 108 provides a command or signal to each of the APU 102 and the GPU 104 to operate at respective frequencies according to the determined power distribution.

In some embodiments, the power distribution module 108 determines a priority bias between the APU 102 and the GPU 104. The priority bias is a quantitative expression of a bias towards providing power and frequencies between the APU 102 and the GPU 104. For example, in some embodiments, the priority bias is expressed as percentile allocations or a ratio between the APU 102 and the GPU 104 (e.g., seventy-five percent bias to the APU 102 and twenty-five percent bias to the GPU 104, fifty percent bias to each of the APU 102 and the GPU 104, and the like). In other words, the priority bias is a modifier which exaggerates or lessens the natural priority delta to try and improves performance even more than the simple default priority delta would do otherwise.

In some embodiments, the priority bias is user defined using an executed application or service, or as a configurable parameter in an operating system or a Basic Input/Output System. As an example, an application presents a user interface element such as a slider that allows a user to allocate a priority bias between the APU 102 and GPU 104. The priority bias is then provided to the power distribution module 108 (e.g., via a driver or other component to the firmware executing the power distribution module 108.

The priority bias affects the power distribution according to various embodiments. For example, in some embodiments, the model 114 to which the first plurality of performance metrics and the second plurality of performance metrics are provided as input is selected based on the priority bias. In other words, the power distribution module 108 determines, based on the priority bias, the model 114 from a plurality of models. For example, assume that each of a plurality of models 114 correspond to a particular range of priority biases (e.g., a first model 114 for one-hundred percent APU 102 bias, a second model for ninety percent APU 102 bias and ten percent GPU 104 bias, and the like). The model 114 is then determined from the plurality of models 114 depending on in which range the priority bias falls. As another example, where the priority bias is selected from a plurality of predefined priority biases, the model 114 is selected as a model 114 corresponding to the predefined priority bias. A model 114 reflects a given priority bias in that various weights, thresholds, and the like used in the model 114 favor outputting power distributions reflecting the priority bias. In other wise, a model 114 corresponding to a priority bias favoring the APU 102 would output power distributions favoring more power and frequency for the APU 102, while a model 114 corresponding to a priority bias favoring the GPU 104 would output power distributions favoring more power and frequency for the GPU 104.

As another example, the inputs to the model 114 (e.g., the first plurality of performance metrics and the second plurality of performance metrics) are modified based on the performance model. In other words, the power distribution module 108 modifies, based on the priority bias between the APU 102 and the GPU 104, at least a portion of the input to the model 114. For example, one or more of the input values to the model 114 are weighted based on the particular ratio or values of the priority bias. As another example, where the priority bias is evenly distributed (e.g., a fifty percent bias for the APU 102 and a fifty percent bias for the GPU 104), the inputs to the model 114 are not modified or weighted based on the priority bias. One skilled in the art will appreciate that the particular weights applied to particular performance metrics are configurable in order to achieve the desired results of having the resulting output of the model 114 (e.g., the resulting power distribution) reflect the biases in the performance bias.

As a further example, the power distribution module 108 modifies, based on the priority bias between the APU 102 and the GPU 104, the power distribution. In some embodiments, the power distribution module 108 weighs the power values or frequency values indicated in the power distribution based on the priority bias. For example, in some embodiments, the power distribution module 108 weighs the power values or frequency values indicated in the power distribution proportionately according to the proportion of APU 102 bias to GPU 104 bias. In some embodiments, the power distribution module 108 overrides the power distribution based on the priority bias. For example, in some embodiments, the power distribution module 108 overrides the power distribution to a power distribution corresponding to a range in which the priority bias falls, or corresponding to a priority bias selected from a plurality of predefined priority biases. One skilled in the art will appreciate that, in some embodiments, the power distribution module 108 either weighs or overrides the power distribution depending on the priority bias. For example, where a portion of the priority bias exceeds a threshold (e.g., a percentile allocation of the priority bias for either the APU 102 or the GPU 104 exceeds a threshold), the power distribution module 108 overrides the power distribution. Where no portion of the priority bias exceeds a threshold, the power distribution module 108 then weighs the power distribution according to the priority bias.

In some embodiments, a particular executed application affects the power distribution determined by the power distribution module 108. For example, the power distribution module 108 identifies an application executed in the apparatus 100. In some embodiments, the particular application being executed is identified by software or a driver and communicated to the power distribution module 108 firmware. The identification of the application includes, for example, a particular application name, an application category, a version number, a vendor or developer, or other information as can be appreciated. As an example, in some embodiments, the identification of the application includes a unique identifier known to the power distribution module 108 for identifying a particular application or type of application.

The power distribution is then determined based on the executed application. For example, in some embodiments, the inputs to the model 114 are weighted based on the executed application. As another example, the executed application is used to affect a determined tie or unchanged power distribution. For example, assume that the power distribution module 108 determines that there are bottlenecks in both the APU 102 and GPU 104, and determines that the current power distribution should remain unchanged. A given executed application then causes the power distribution module 108 to modify the power distribution to some amount favoring either the APU 102 or the GPU 104. For example, assuming that an identified application is a particular game or identified as a game, the power distribution module 108 determines to modify the power distribution to increase power and frequency for the GPU 104 in order to achieve better rendering performance.

In some embodiments, the power distribution is overridden based on the executed application. Consider an example where a particular application that results in performance characteristic behavior that would be identified by the model 114 as a GPU 104 bottleneck and would result in a power distribution that increases power and frequency for the GPU 104. However, the particular application is a known outlier in that it has been previously determined that the particular application receives performance increases when power and frequency are instead increased for the APU 102. In response to determining that the particular application is executed, the power distribution module 108 overrides the determined power distribution for a power distribution whereby the APU 102 is allocated more power and frequency.

Although the power distribution module 108 is described above as being executed in the firmware of an APU 102 for which the power distribution is determined, one skilled in the art will appreciate that, in some multi-core embodiments, the power distribution module 108 is executed in a core separate from the APU 102 for which the power distribution is determined. Moreover, one skilled in the art will appreciate that, in some embodiments, the approaches described above are applicable for systems with additional APUs 102, or GPUs 104 and that a power distribution is determined applicable for each APU 102 and GPU 104 (e.g., further based on performance metrics received from the additional APUs 102 and GPUs 104).

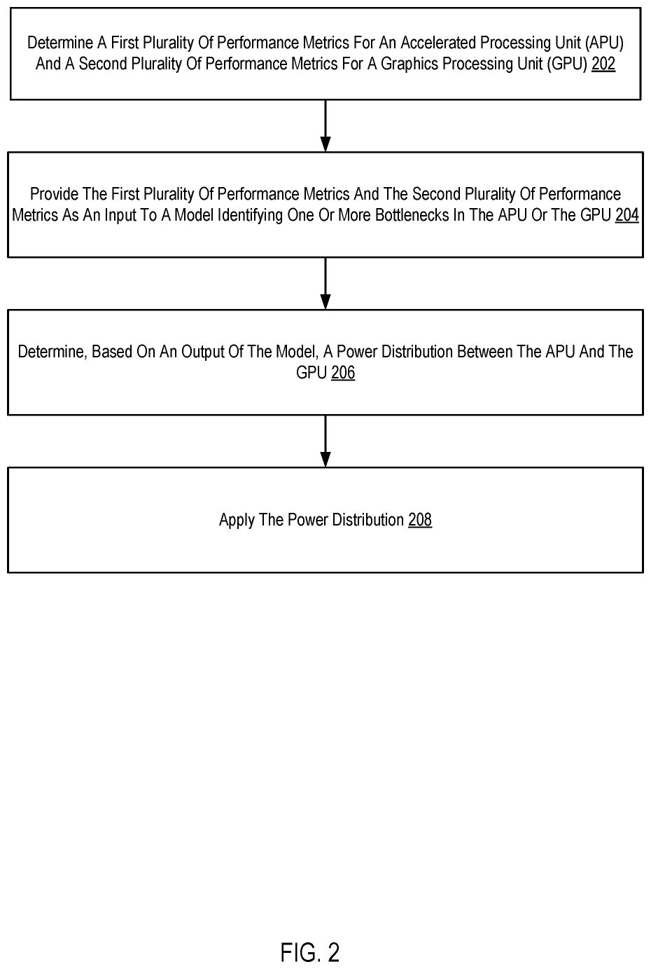

For further explanation, FIG. 2 sets forth a flow chart illustrating an example method for power shifting based on bottleneck prediction that includes determining 202 (e.g., by a power distribution module 108) a first plurality of performance metrics for an APU 102 and a second plurality of performance metrics for a GPU 104. In some embodiments, the first plurality of performance metrics and the second plurality of performance metrics include counters describing a number of times a particular event has occurred in the APU 102 or GPU 104 (e.g., in total, within a particular time interval, and the like). As an example, the first plurality of performance metrics and the second plurality of performance metrics include instruction retirement metrics such as counters describing a number of instructions retired or committed (e.g., in total or with respect to a particular type of instruction). As another example, the first plurality of performance metrics and the second plurality of performance metrics include memory utilization metrics such as a number of memory accesses (e.g., accesses to memory 105 or memory 106) or a number of a particular type of memory access (e.g., read or write). As another example, the first plurality of performance metrics and the second plurality of performance metrics include cache activity metrics such as a number of cache hits or cache misses. As a further example, the first plurality of performance metrics and the second plurality of performance metrics include bus utilization metrics such as a degree of usage of a memory bus, a PCIe bus (e.g., the PCIe bus between the APU 102 and the GPU 104), and the like. In some embodiments, the first plurality of performance metrics and the second plurality of performance metrics include a degree of occupancy or utilization of the APU 102 and GPU 104. One skilled in the art will appreciate that other performance metrics are also usable in the approaches set forth herein.

In some embodiments, the first plurality of performance metrics are received by the power distribution module 108 from a first microcontroller 110 of the APU 102 and the second plurality of performance metrics are received from a second microcontroller 112 of the GPU 104. For example, the first microcontroller 110 calculates the first plurality of performance metrics relative to the APU 102 (e.g., instructions retired by the APU 102, memory accesses by the APU 102, bus utilization by the APU 102, and the like) and provides the first plurality of performance metrics to the power distribution module 108. The second microcontroller 112 calculates the second plurality of performance metrics relative to the GPU 104 (e.g., instructions retired by the GPU 104, memory accesses by the GPU 104, bus utilization by the GPU 104, and the like) and provides the second plurality of performance metrics to the power distribution module 108.

The method of FIG. 2 also includes providing 204 (e.g., by the power distribution module 108), the first plurality of performance metrics and the second plurality of performance metrics as input to a model 114 identifying one or more bottlenecks in the APU 102 or the GPU 104. As an example, in some embodiments, the model 114 includes a trained machine learning model 114 trained to identify one or more bottlenecks in the APU 102 or the GPU 104 based on the first plurality of performance metrics and the second plurality of performance metrics. As another example, in some embodiments, the model 114 includes an algorithmic or user-defined model 114 based on identifying bottlenecks in the APU 102 or the GPU 104. In some embodiments, the model 114 is stored in the firmware of the APU 102. In some embodiments, the model 114 is trained or generated prior to storage in the firmware of the APU 102 (e.g., trained or generated off-chip).

Various behaviors relating to the first plurality of performance metrics and the second plurality of performance metrics will indicate a bottleneck in the APU 102 or the GPU 104. For example, where the occupancy or usage of the APU 102 or GPU 104 is at or near a maximum, this indicates a bottleneck at the respective APU 102 or GPU 104. As another example, there usage or a component is lower, or a component is performing relatively few instruction retirement events, it indicates that the particular component is likely not the source of a bottleneck. As a further example, a component experiencing a large degree of cache misses is potentially the source of a bottleneck. One skilled in the art will appreciate that various behaviors associated with the first plurality of performance metrics and the second plurality of performance metrics, and that the particular relationships between performance metrics and bottlenecks will be expressed in the particular trainings or encodings of the model 114.

The method of FIG. 2 also includes determining 206 (e.g., by the power distribution module 108), based on an output of the model 114, a power distribution between the APU 102 and the GPU 104. In some embodiments, the model 114 outputs output the power distribution directly. That is, in some embodiments, the output of the model 114 includes a first power level and a first frequency for the APU 102 and a second power level and a second frequency for the GPU 104. Accordingly, the power distribution determined by the power distribution module 108 is the output of the model 114 itself. In other embodiments, the output of the model 114 includes one or more confidence scores relative to a particular power distribution. Accordingly, in such an embodiment, the power distribution module 108 determines the power distribution based on the confidence scores output by the power distribution module 108. In further embodiments, the output of the model 114 includes an amount to modify the power and frequency of the APU 102 and GPU 104 (e.g., a particular amount to shift the power up or down for each of the APU 102 and GPU 104 and a particular amount to shift the frequency up or down for each of the APU 102 and GPU 104). The power distribution module 108 then determines the power distribution between the APU 102 and the GPU 104 by calculating updated respective power levels and frequencies for the APU 102 and the GPU 104.

The method of FIG. 2 also includes applying 208 (e.g., by the power distribution module 108) the power distribution. For example, the power distribution module 108 provides a command or signal to a voltage controller or other power regulating component of the apparatus to provide power to the APU 102 and the GPU 104 according to the determined power distribution. As another example, the power distribution module 108 provides a command or signal to each of the APU 102 and the GPU 104 to operate at respective frequencies according to the determined power distribution.

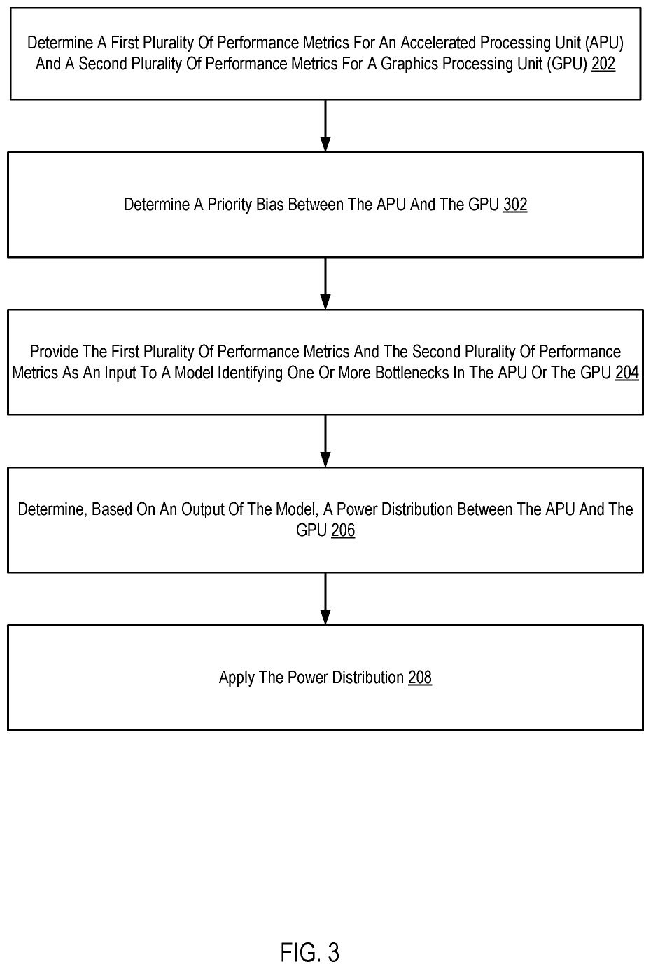

For further explanation, FIG. 3 sets forth a flow chart illustrating another example method for power shifting based on bottleneck prediction according to embodiments of the present disclosure. The method of FIG. 3 is similar to that of FIG. 2 in that the method of FIG. 3 also includes determining 202 a first plurality of performance metrics for an APU 102 and a second plurality of performance metrics for a GPU 104; providing 204, the first plurality of performance metrics and the second plurality of performance metrics as input to a model 114 identifying one or more bottlenecks in the APU 102 or the GPU 104; determining 206, based on an output of the model 114, a power distribution between the APU 102 and the GPU 104; and applying 208 the power distribution.

The method of FIG. 3 differs from FIG. 2 in that the method of FIG. 3 includes determining 302 a priority bias between the APU 102 and the GPU 104. The priority bias is a quantitative expression of a bias towards providing power and frequencies between the APU 102 and the GPU 104. For example, in some embodiments, the priority bias is expressed as percentile allocations or a ratio between the APU 102 and the GPU 104 (e.g., seventy-five percent bias to the APU 102 and twenty-five percent bias to the GPU 104, fifty percent bias to each of the APU 102 and the GPU 104, and the like).

In some embodiments, the priority bias is user defined using an executed application or service, or as a configurable parameter in an operating system or a Basic Input/Output System. As an example, an application presents a user interface element such as a slider that allows a user to allocate a priority bias between the APU 102 and GPU 104. The priority bias is then provided to the power distribution module 108 (e.g., via a driver or other component to the firmware executing the power distribution module 108.

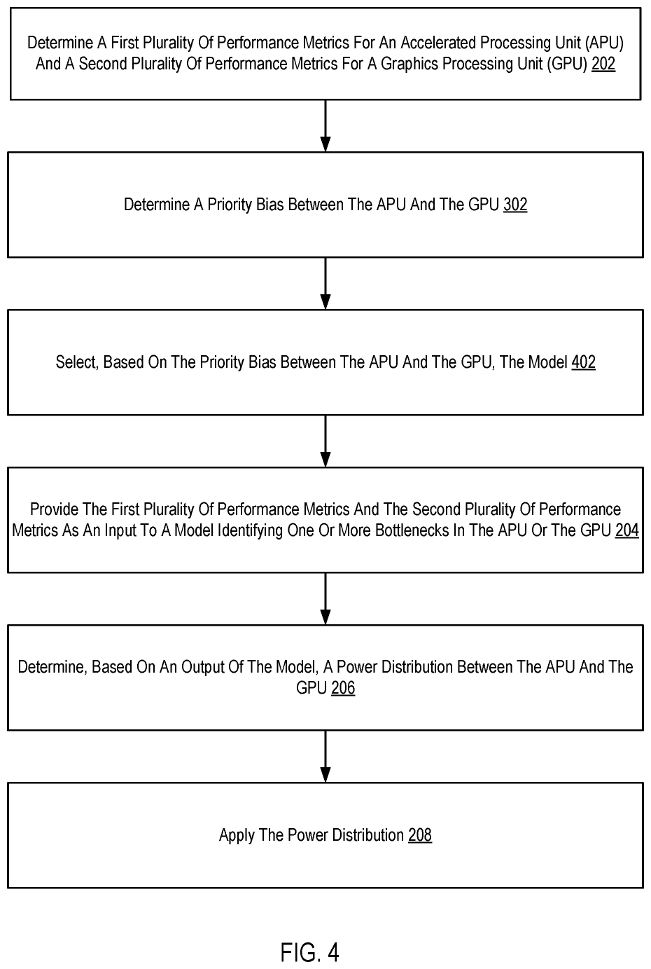

For further explanation, FIG. 4 sets forth a flow chart illustrating another example method for power shifting based on bottleneck prediction according to embodiments of the present disclosure. The method of FIG. 4 is similar to that of FIG. 3 in that the method of FIG. 4 also includes determining 202 a first plurality of performance metrics for an APU 102 and a second plurality of performance metrics for a GPU 104; determining 302 a priority bias between the APU 102 and the GPU 104; providing 204, the first plurality of performance metrics and the second plurality of performance metrics as input to a model 114 identifying one or more bottlenecks in the APU 102 or the GPU 104; determining 206, based on an output of the model 114, a power distribution between the APU 102 and the GPU 104; and applying 208 the power distribution.

The method of FIG. 4 differs from FIG. 3 in that the method of FIG. 4 includes selecting 402 (e.g., by the power distribution module 108), based on the priority bias between the APU 102 and the GPU 104, the model 114. For example, assume that each of a plurality of models 114 correspond to a particular range of priority biases (e.g., a first model 114 for one-hundred percent APU 102 bias, a second model for ninety percent APU 102 bias and ten percent GPU 104 bias, and the like). The model 114 is then determined from the plurality of models 114 depending on in which range the priority bias falls. As another example, where the priority bias is selected from a plurality of predefined priority biases, the model 114 is selected as a model 114 corresponding to the predefined priority bias. A model 114 reflects a given priority bias in that various weights, thresholds, and the like used in the model 114 favor outputting power distributions reflecting the priority bias. In other wise, a model 114 corresponding to a priority bias favoring the APU 102 would output power distributions favoring more power and frequency for the APU 102, while a model 114 corresponding to a priority bias favoring the GPU 104 would output power distributions favoring more power and frequency for the GPU 104.

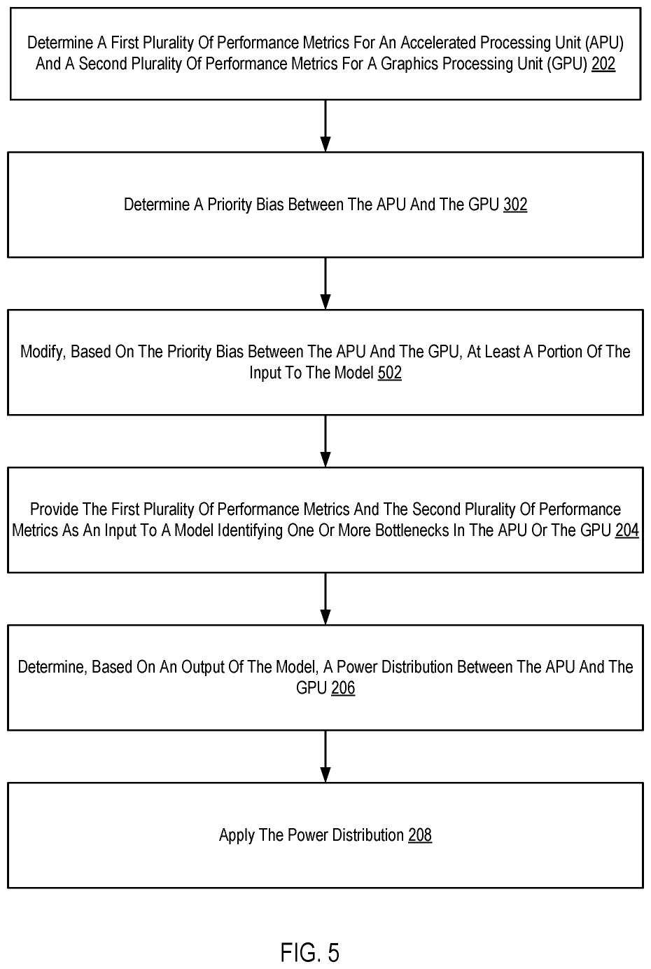

For further explanation, FIG. 5 sets forth a flow chart illustrating another example method for power shifting based on bottleneck prediction according to embodiments of the present disclosure. The method of FIG. 5 is similar to that of FIG. 3 in that the method of FIG. 5 also includes determining 202 a first plurality of performance metrics for an APU 102 and a second plurality of performance metrics for a GPU 104; determining 302 a priority bias between the APU 102 and the GPU 104; providing 204, the first plurality of performance metrics and the second plurality of performance metrics as input to a model 114 identifying one or more bottlenecks in the APU 102 or the GPU 104; determining 206, based on an output of the model 114, a power distribution between the APU 102 and the GPU 104; and applying 208 the power distribution.

The method of FIG. 5 differs from FIG. 3 in that the method of FIG. 5 includes modifying 502 (e.g., by the power distribution module 108), based on the priority bias between the APU 102 and the GPU 104, at least a portion of the input to the model 114. For example, one or more of the input values to the model 114 are weighted based on the particular ratio or values of the priority bias. As another example, where the priority bias is evenly distributed (e.g., a fifty percent bias for the APU 102 and a fifty percent bias for the GPU 104), the inputs to the model 114 are not modified or weighted based on the priority bias. One skilled in the art will appreciate that the particular weights applied to particular performance metrics are configurable in order to achieve the desired results of having the resulting output of the model 114 (e.g., the resulting power distribution) reflect the biases in the performance bias.

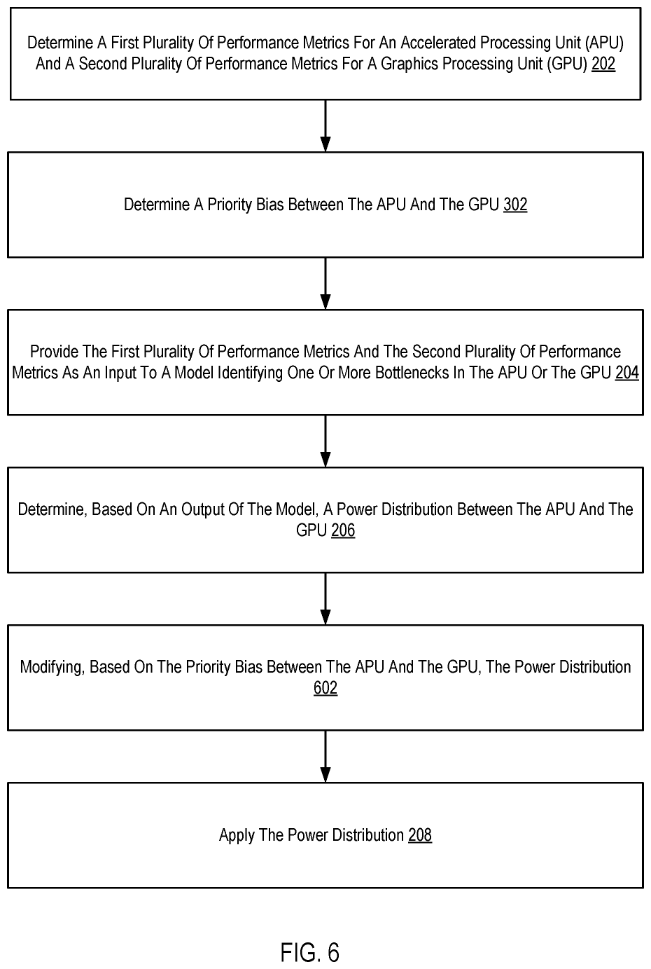

For further explanation, FIG. 6 sets forth a flow chart illustrating another example method for power shifting based on bottleneck prediction according to embodiments of the present disclosure. The method of FIG. 6 is similar to that of FIG. 3 in that the method of FIG. 6 also includes determining 202 a first plurality of performance metrics for an APU 102 and a second plurality of performance metrics for a GPU 104; determining 302 a priority bias between the APU 102 and the GPU 104; providing 204, the first plurality of performance metrics and the second plurality of performance metrics as input to a model 114 identifying one or more bottlenecks in the APU 102 or the GPU 104; determining 206, based on an output of the model 114, a power distribution between the APU 102 and the GPU 104; and applying 208 the power distribution.

The method of FIG. 6 differs from FIG. 3 in that the method of FIG. 6 includes modifying 602 (e.g., by the power distribution module 108), based on the priority bias between the APU 102 and the GPU 104, the power distribution. In some embodiments, the power distribution module 108 weighs the power values or frequency values indicated in the power distribution based on the priority bias. For example, in some embodiments, the power distribution module 108 weighs the power values or frequency values indicated in the power distribution proportionately according to the proportion of APU 102 bias to GPU 104 bias. In some embodiments, the power distribution module 108 overrides the power distribution based on the priority bias. For example, in some embodiments, the power distribution module 108 overrides the power distribution to a power distribution corresponding to a range in which the priority bias falls, or corresponding to a priority bias selected from a plurality of predefined priority biases. One skilled in the art will appreciate that, in some embodiments, the power distribution module 108 either weighs or overrides the power distribution depending on the priority bias. For example, where a portion of the priority bias exceeds a threshold (e.g., a percentile allocation of the priority bias for either the APU 102 or the GPU 104 exceeds a threshold), the power distribution module 108 overrides the power distribution. Where no portion of the priority bias exceeds a threshold, the power distribution module 108 then weighs the power distribution according to the priority bias.

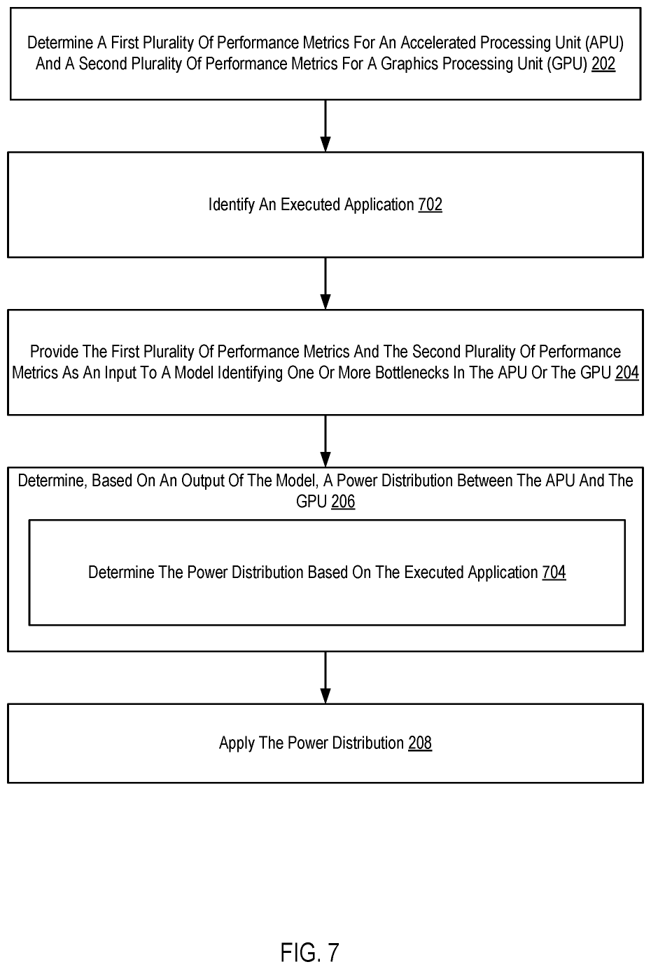

For further explanation, FIG. 7 sets forth a flow chart illustrating another example method for power shifting based on bottleneck prediction according to embodiments of the present disclosure. The method of FIG. 7 is similar to that of FIG. 2 in that the method of FIG. 7 also includes determining 202 a first plurality of performance metrics for an APU 102 and a second plurality of performance metrics for a GPU 104; providing 204, the first plurality of performance metrics and the second plurality of performance metrics as input to a model 114 identifying one or more bottlenecks in the APU 102 or the GPU 104; determining 206, based on an output of the model 114, a power distribution between the APU 102 and the GPU 104; and applying 208 the power distribution.

The method of FIG. 7 differs from FIG. 2 in that the method of FIG. 7 includes identifying 702 (e.g., by the power distribution module 108) an executed application (e.g., executed in the apparatus 100). In some embodiments, the particular application being executed is identified 702 by software or a driver and communicated to the power distribution module 108 firmware. The identification of the application includes, for example, a particular application name, an application category, a version number, a vendor or developer, or other information as can be appreciated. As an example, in some embodiments, the identification of the application includes a unique identifier known to the power distribution module 108 for identifying a particular application or type of application.

The method of FIG. 7 further differs from FIG. 2 in that determining 206, based on the output of the model, a power distribution between the APU 102 and the GPU 104 includes determining 704 the power distribution based on the executed application. For example, in some embodiments, the inputs to the model 108 are weighted based on the executed application. As another example, the executed application is used to affect a determined tie or unchanged power distribution. For example, assume that the power distribution module 108 determines that there are bottlenecks in both the APU 102 and GPU 104, and determines that the current power distribution should remain unchanged. A given executed application then causes the power distribution module 108 to modify the power distribution to some amount favoring either the APU 102 or the GPU 104. For example, assuming that an identified application is a particular game or identified as a game, the power distribution module 108 determines to modify the power distribution to increase power and frequency for the GPU 104 in order to achieve better rendering performance.

In some embodiments, the power distribution is overridden based on the executed application. Consider an example where a particular application that results in performance characteristic behavior that would be identified by the model 114 as a GPU 104 bottleneck and would result in a power distribution that increases power and frequency for the GPU 104. However, the particular application is a known outlier in that it has been previously determined that the particular application receives performance increases when power and frequency are instead increased for the APU 102. In response to determining that the particular application is executed, the power distribution module 108 overrides the determined power distribution for a power distribution whereby the APU 102 is allocated more power and frequency.

In view of the explanations set forth above, readers will recognize that the benefits of power shifting based on bottleneck prediction include:
Improved performance of a computing system by alleviating APU and GPU bottlenecks by reallocating power to affected components.
Improved performance of a computing system by providing for user-defined priority biases in distributing power between an APU and a GPU.

Exemplary embodiments of the present disclosure are described largely in the context of a fully functional computer system for power shifting based on bottleneck prediction. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

1. A method of power shifting based on bottleneck prediction, the method comprising:
determining, by a power distribution circuit of an accelerated processing unit (APU), a first plurality of performance metrics for the APU and a second plurality of performance metrics for a graphics processing unit (GPU);
providing, by the power distribution circuit, the first plurality of performance metrics and the second plurality of performance metrics as an input to a machine learning model configured to identify one or more bottlenecks in the APU or the GPU;
determining, by the power distribution circuit based on an output of the model, a power distribution between the APU and the GPU; and
applying, by the power distribution circuit, the power distribution to distribute an amount of power between the APU and the GPU.

2. The method of claim 1, further comprising determining a priority bias between the APU and the GPU.

3. The method of claim 2, further comprising determining, based on the priority bias between the APU and the GPU, the model from a plurality of models.

4. The method of claim 2, further comprising modifying, based on the priority bias between the APU and the GPU, at least a portion of the input to the model.

5. The method of claim 2, further comprising modifying, based on the priority bias between the APU and the GPU, the power distribution.

6. The method of claim 1, further comprising:
identifying an executed application; and
wherein determining the power distribution comprises determining the power distribution based on the executed application.

7. The method of claim 1, wherein the output of the model comprises a first power level and a first frequency for the APU and a second power level and a second frequency for the GPU.

8. The method of claim 1, wherein the plurality of first performance metrics or the plurality of second performance metrics comprise one or more of: one or more instruction retirement metrics, one or more memory utilization metrics, one or more cache activity metrics, or one or more bus utilization metrics.

9. The method of claim 1, wherein the first plurality of performance metrics are received from a first microcontroller of the APU and the second plurality of performance metrics are received from a second microcontroller of the GPU.

10. An apparatus for power shifting based on bottleneck prediction, the apparatus comprising:
an APU;
a GPU; and
wherein the apparatus is configured to perform steps comprising:
determining, by a power distribution circuit of the APU, a first plurality of performance metrics for the APU and a second plurality of performance metrics for the GPU;
providing, by the power distribution circuit, the first plurality of performance metrics and the second plurality of performance metrics as an input to a machine learning model configured to identify one or more bottlenecks in the APU or the GPU;
determining, by the power distribution circuit based on an output of the model, a power distribution between the APU and the GPU; and
applying, by the power distribution circuit, the power distribution to distribute an amount of power between the APU and the GPU.

11. The apparatus of claim 10, wherein the steps further comprise determining a priority bias between the APU and the GPU.

12. The apparatus of claim 11, wherein the steps further comprise determining, based on the priority bias between the APU and the GPU, the model from a plurality of models.

13. The apparatus of claim 11, wherein the steps further comprise modifying, based on the priority bias between the APU and the GPU, at least a portion of the input to the model.

14. The apparatus of claim 11, wherein the steps further comprise modifying, based on the priority bias between the APU and the GPU, the power distribution.

15. The apparatus of claim 10, wherein the steps further comprise:
identifying an executed application; and
wherein determining the power distribution comprises determining the power distribution based on the executed application.

16. The apparatus of claim 10, wherein the output of the model comprises a first power level and a first frequency for the APU and a second power level and a second frequency for the GPU.

17. The apparatus of claim 10, wherein the plurality of first performance metrics or the plurality of second performance metrics comprise one or more of: one or more instruction retirement metrics, one or more memory utilization metrics, one or more cache activity metrics, or one or more bus utilization metrics.

18. The apparatus of claim 10, wherein the first plurality of performance metrics are received from a first microcontroller of the APU and the second plurality of performance metrics are received from a second microcontroller of the GPU.

19. A computer program product disposed upon a non-transitory computer readable medium, the computer program product comprising computer program instructions for power shifting based on bottleneck prediction, that, when executed, cause a computer system to perform steps comprising:
determining, by a power distribution circuit of an accelerated processing unit (APU), a first plurality of performance metrics for the APU and a second plurality of performance metrics for a GPU;
providing, by the power distribution circuit, the first plurality of performance metrics and the second plurality of performance metrics as an input to a machine learning model configured to identify one or more bottlenecks in the APU or the GPU;
determining, by the power distribution circuit based on an output of the model, a power distribution between the APU and the GPU; and
applying, by the power distribution circuit, the power distribution to distribute an amount of power between the APU and the GPU.

20. The computer program product of claim 19, wherein the steps further comprise determining a priority bias between the APU and the GPU.
